(19) United States
(12) Patent Application Publication
(10) Pub. No.: US 2003/0175069 A1
(43) Pub. Date: Sep. 18, 2003

(54) Spherical joint mechanism

(76) Inventors: Paul Michael Bosscher, Atlanta, GA (US); Imme Ruth Ebert-Uphoff, Roswell, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/357,662

(22) Filed: Feb. 4, 2003

Related U.S. Application Data
(60) Provisional application No. 60/364,186, filed on Mar. 13, 2002.

(51) Int. Cl. F16L 41/00

(52) U.S. Cl. 403/170

(57) ABSTRACT

A plurality of main links and a plurality of connection links define a spherical joint. Each of the main links are adapted to couple to other bodies and are serially and pivotally connected by the plurality of connection links that extend between adjacent main links. Each connection link includes at least two connection segments, which are pivotally coupled together by a pivotal coupler that defines an axis of rotation. The axes of rotation defined by all of the couplers intersect at a common point about which the main links can move in spherical motion.

### CROSS-REFERENCE TO RELATED APPLICATION

This application claims priority to co-pending U.S. provisional application entitled, “JOINT MECHANISM THAT ALLOWS SEVERAL LINKS TO COME TOGETHER TO A SINGLE SPHERICAL JOINT,” having Ser. No. 60/364,186, filed Mar. 13, 2002, which is entirely incorporated herein by reference.

This application is related to co-pending U.S. patent application entitled “DIGITAL CLAY APPARATUS AND METHOD” filed on Jun. 7, 2002, and accorded Ser. No. 10/164,888, which is entirely incorporated herein by reference.

### TECHNICAL FIELD

The present invention is generally related to joint mechanisms and, more particularly, is related to a spherical joint mechanism for providing spherical motion about a particular point.

### BACKGROUND OF THE INVENTION

Prior art joint mechanisms for providing spherical motion include conventional ball-socket joints, in which a ball is rotatable within a concave hemispherical socket. The point about which the ball rotates, the spherical rotation point, is the center of the ball. The range of motion of a ball-socket joint is limited because the spherical rotation point is located with the ball-socket joint, and it is generally impossible to have multiple ball-socket joints sharing a common spherical rotation point.

Other types of joints may also provide spherical motion, such as spherical joint mechanisms having links that lie on the surface of a sphere. Typically, in these types of joints, the spherical rotation point may not be occupied by any part of the mechanism, and access to the spherical rotation point may be obscured by the moving links and the center of rotation surrounded by the mechanism. With these types of joints, it is possible to have one or more joints share a common spherical rotation point. However, the interface between mechanisms often greatly reduces the range of motion of each joint.

Typically, other than the ball-socket joint, spherical joints are complicated mechanisms, usually requiring a high level of manufacturing precision.

Thus, a heretofore unaddressed need exists in the industry to address the aforementioned deficiencies and inadequacies.

### SUMMARY OF THE INVENTION

Embodiments of the present invention provide a joint mechanism for providing spherical motion about a point. Briefly described, in architecture, one embodiment of the system, among others, can be implemented as follows.

In a preferred embodiment, the present invention relates to a joint mechanism having a plurality of main links and a plurality of connection links that are pivotally connected to the main links. The main links are serially connected together by the connection links. Each one of the main links defines an axis, and the axes of the main links intersect at a given point. Each one of the connection links includes multiple connection segments that are pivotally connected together. Pivotally connected connection segments pivot about an axis of rotation that intersects with the given point. The given point is the spherical rotation point about which the main links move in spherical motion.

In one preferred embodiment, each one of the connection links extends between a pair of main links at unique radius from the spherical rotation point. Because each one of the connection links has a unique radius from the spherical rotation point, they occupy different shells centered upon the spherical rotation point and they do not interfere with each other as the spherical joint is being manipulated.

In one preferred embodiment, a sheet of spherical joints is coupled to a computing device and a positioner. The sheet of spherical joints can be manipulated or molded into three-dimensional shapes. The computing device is in communication with each of the spherical joints and can determine the position of the spherical joints relative to a reference point and generate therefrom an image of the molded sheet of spherical joints. The spherical joints include positioning actuators for positioning main links and connection links of the spherical joints. The positioning actuators are controlled by the positioner.

Other features and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

Reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications and equivalents included within the spirit and scope of the invention as defined by the appended claims.

### BRIEF DESCRIPTION OF THE DRAWINGS

The accompanying drawings incorporated in and forming a part of the specification illustrate several aspects of the present invention, and together with the description serve to explain the principles of the invention. The components in the drawings are not necessarily to scale, emphasis instead being placed upon clearly illustrating the principles of the present invention. Moreover, in the drawings, like reference numerals designate corresponding parts throughout the several views.

FIG. 1 is a top view of a closed circumference spherical joint having two main links.

FIG. 2 is a top view of a closed circumference spherical joint having four main links.

FIG. 3 is a top view of a closed circumference spherical joint having 3 main links.

FIG. 4A is a perspective view of a closed circumference spherical joint having four main links.

FIG. 4B is a top view of the spherical joint of FIG. 4A.

FIG. 4C is a cross sectional view of a main link of the spherical joint of FIG. 4A.

FIG. 5A is a top view of a blank used in a spherical joint.

FIG. 5B is a top view of two links in a spherical joint.

FIG. 6 is a top view of a digital clay system implemented using a grid of connected spherical joints.

FIG. 7A is a side view of two links and a deflated link positioner.

FIG. 7B is a side view of the two links and link positioner of FIG. 7A with the link positioner inflated.

### DETAILED DESCRIPTION OF THE PREFERRED EMBODIMENT

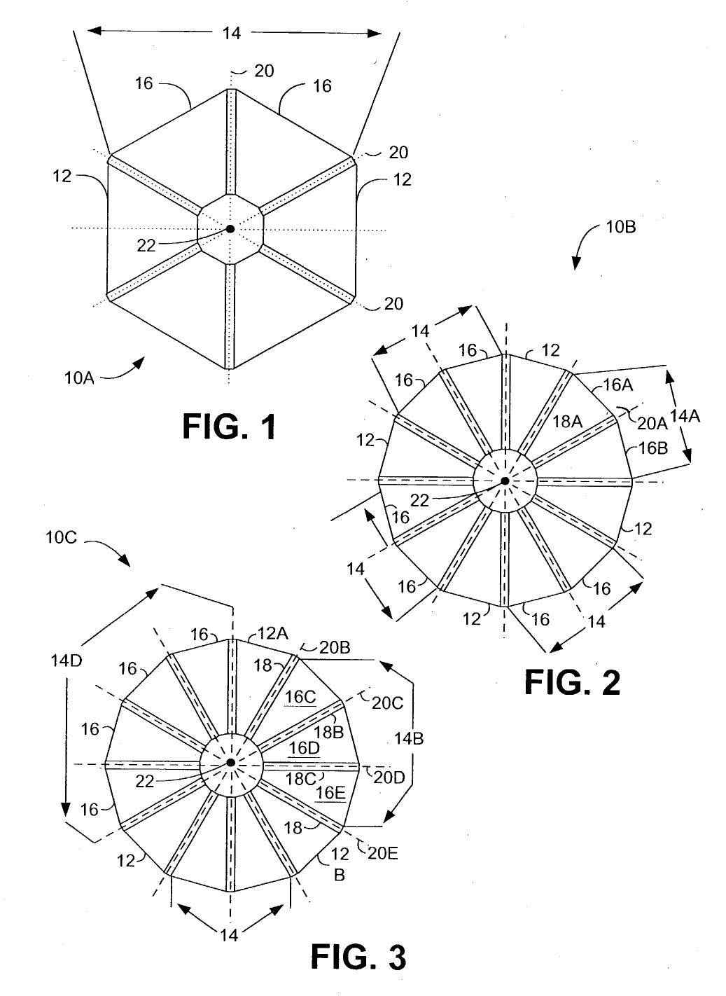

In FIGS. 1, 2, 3, and 4, non-limiting examples of spherical joints 10A-10D, respectively, are illustrated. Each one of the spherical joints 10 includes at least one main link 12 and a plurality of connection links 14. The main links 12 are pivotally coupled to connection links 14 by pivotal couplers 18 such that the mail links 12 have three rotational degrees of freedom. The main links 12 are primarily used for coupling the spherical joint to other bodies (not shown).

Extending between adjacent pairs of main links 12 are the connection links 14, which act as coupling assemblies for coupling the main links 12 together. Each one of the connection links 14 includes at least two connection segments 16, which are pivotally coupled together by at least one pivotal coupler 18, and each pivotal coupler 18 defines an axis of rotation 20. For each of the spherical joints 10, the axis of rotation 20, intersect at a single intersection point 22, the spherical rotation point of the spherical joint 10.

Referring to FIG. 2, connection link 14A includes connection segments 16A and 16B, which are pivotally connected by the pivotal coupler 18A. The pivotal coupler 18A defines the axis of rotation 20A about which the connection segments 16A and 16B can rotate. Pivotal couplers include, but are not limited to, flexure joints, revolute joints, and hinges.

In FIG. 3, in an alternative embodiment, connection link 14B includes connection segments 16C, 16D and 16E, which are serially and pivotally connected together by pivotal couplers 18B and 18C. In this exemplary embodiment, there are four axes of rotation, 20B-20E, between the main links 12A and 12B.

Whether a connection link 14 includes more than two connection segments 16 that are serially and pivotally connected together is a design choice, and all embodiments having more than two pivotally coupled connection segments 16 are intended to be within the scope of the invention. For example, connection link 14C includes four connection segments 16.

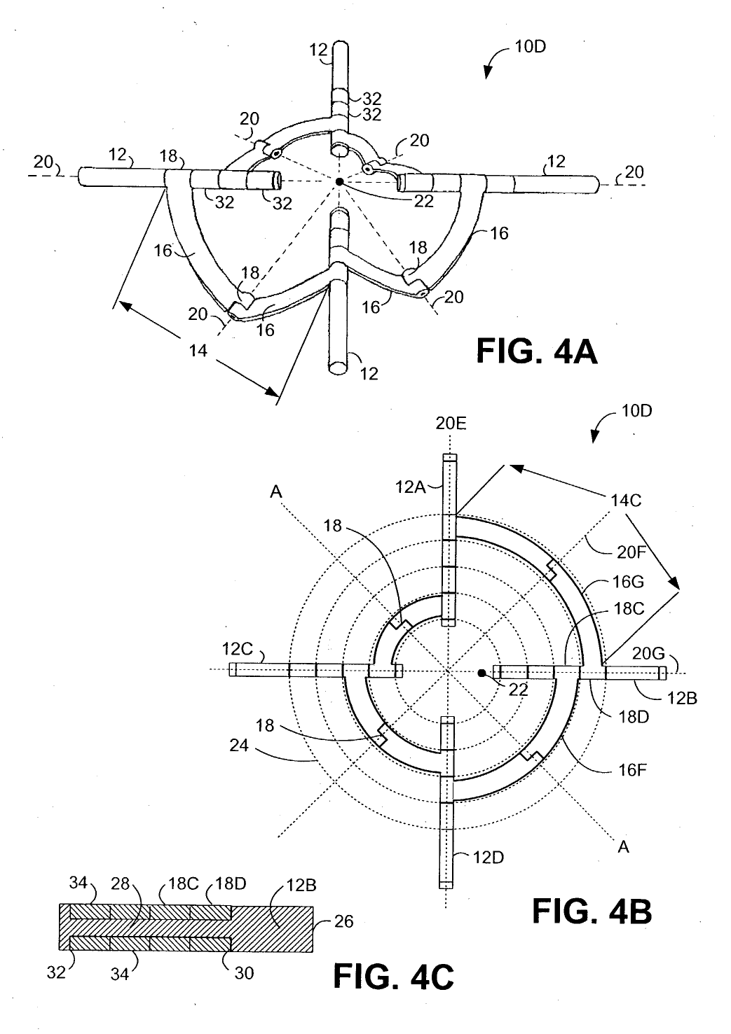

Referring to FIGS. 4A and 4B, FIG. 4A is a perspective view of the spherical joint 10D, and in FIG. 4B the spherical joint 10B is shown from above. In this embodiment of the invention, the main links 12 are shafts or pins, which define a longitudinal axis, and each one of the main links 12 are aligned such that the longitudinal axis of the main links are radially aligned with the spherical rotation point 22. Extending between adjacent main links 12 are the connection links 14. Each connection link 14 is made up of at least two connection segments 16, which are pivotally coupled together by a pivotal coupler 18. Each one of the pivotal couplers 18 defines a rotational axis 20, and the rotational axes 20 intersect at the spherical rotation point 22.

Referring to FIG. 4B, the concentric dashed lines 24 represent shells centered about the spherical rotation point 22. Each one of the shells represents the region of space that a connection link can traverse about the spherical rotation point 22 without interference from another connection link. For example, as the spherical joint 10D is folded about the dashed line A-A, portions of the connection link 14C traverse through the outer shell between main links 12C and 12D. Although the main links 12 can interfere with each other, for example, main links 12C and 12A will contact each other as the spherical joint 10D is folded in half about the dashed line A-A, the connection links 14 between the different pairs of main links do not interfere because they are radially staggered and occupy different shells around the spherical rotation point 22.

A cross-sectional view of main link 12B is illustrated in FIG. 4C. The main link 12C includes a main body 26 and a shaft 28. The shaft 28 is circular in cross-section and extends between opposed ends 30 and 32, each of which has a radius greater than the radius of the shaft 28. Disposed between the opposed ends 30 and 32 are pivotal couplers 18C and 18D and spacers 34.

The pivotal couplers 18C and 18D are generally tubular in shape having a generally cylindrical hollow interior through which the shaft 28 passes. Extending outward from the pivotal couplers 18C and 18D are the connection segments 16F and 16G, respectively (see FIG. 4B).

The spacers 34 extend from the pivotal coupler 18C to the end 30 of shaft 28. The spacers 34 prevent the pivotal couplers 18C and 18D from moving radially along the shaft 28, thereby keeping each of the connection links 14 in their respective shells 24.

It should be noted that the pivotal couplers 18C and 18D allow the connection segments 16F and 16G one degree of rotational freedom about shaft 28. Because there is at least one pivotal coupler 18 serially connecting the connection segments 16 of a connection link 14 extending between adjacent main links 12 and because the connection link 14 is pivotally coupled to each of the adjacent main links 12, there are effectively three axes of rotation between the adjacent main links, which results in the adjacent main links having three degrees of rotational freedom.

Although the spherical joints 10A through 10D illustrated in FIGS. 1-4, respectively, are shown as closed perimeter spherical joints, in an alternative embodiment a spherical joint can define an open perimeter. Whether a spherical joint 10 defines an open perimeter or a closed perimeter is a design choice. However, closed perimeter spherical joints provide greater rigidity than open perimeter spherical joints. Also, the rigidity of the spherical joint depends in part on the material from which the main links 12 and connection links 14 are made and from the type of pivotal coupler 18 that is employed. For example, a revolute joint employing aligned tubes and a pin will be more rigid than a flexure joint made from a material such as plastic.

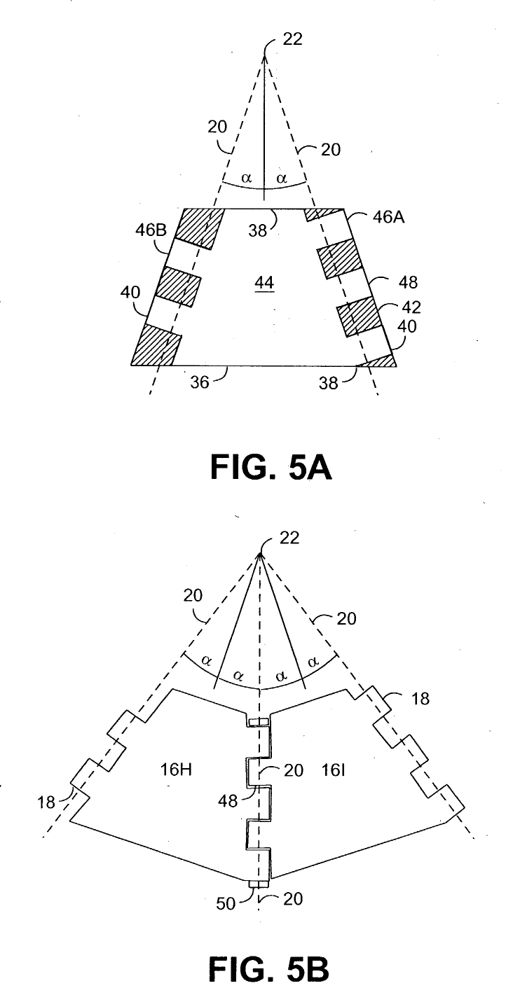

Illustrated in FIGS. 5A and 5B is an exemplary method of manufacturing the main links 12 and the connection segments 16 of a spherical joint 10 having revolute joints. Typically, this embodiment is employed in spherical joints that require a great deal of strength and rigidity. Those skilled in the art will recognize other methods for manufacturing spherical joints 10 such as, but not limited to, a rapid prototype fabrication method such as, but not limited to, stereo lithography and material disposition.

Referring to FIG. 5A, a blank 36 of material, which is typically a metal such as, but not limited to, steel, aluminum, copper, brass, titanium, etc., is formed into a trapezoid having parallel sides 38 and non-parallel sides 40. The dashed lines 20 in FIG. 5A signify the axis of rotation and the shaded areas 42 represent the region of material of blank 36 is removed. Once the shaded areas 42 have been removed from blank 36, the blank 36 defines a main body 44 having a plurality of tabs 46 that extend generally outward from the main body 44.

Each of the tabs 46 defines an end 48 distal from the main body 44, and each end 48 is rolled backwards toward the main body 44 about the axis of rotation 20 such that each of the tabs 46 are formed into tubular segments. The tabs 46A and 46B are offset so that when they are rolled into the generally tubular segments, they will abut tubes of adjacent connection segments 16.

The angle alpha, which defines the non-parallel sides 40 of blank 36 is approximately 360°/2N, where N is the number of connection segments 16 in a closed parameter spherical joint. For an open perimeter spherical joint, alpha can be any number less than 120°.

Referring to FIG. 5B, which illustrates the pivotal connection of two connection segments 16H and 16I which were formed from a pair of blanks 36, the connection segments 16H and 16I are pivotally coupled together by a pin 50 that extends through pivotal couplers 18. The pin 50 and the pivotal couplers 18 define a revolute joint having an axis of rotation 20 that intersects with the spherical rotation point 22.

In this exemplary embodiment, the pivotal couplers 18 are tubular segments that were formed by rolling tabs 46 into generally cylindrically shaped tubes. As previously mentioned hereinabove, the pivotal couplers 18 (tabs 46) are offset on one side of the connection segment 16 (main body 44) from the pivotal couplers 18 (tabs 46) on the other side so that each side can mate with an adjacent connection segment 16.

It should be noted that in this embodiment, that the connection segments 16 and main links 12 are essentially identical. Among other things, main links 12 are used to couple the spherical joint to other bodies (not shown) and are separated by at least two pivotally connected connection segments 16 such that each main link 12 has three degrees of rotational freedom.

Furthermore, it should be noted that the use of revolute joints is a matter of implementation and should be considered as a non-limiting example. Those skilled in the art will recognize other pivotal joints such as, but not limited to, flexure joints, which can be implemented in embodiments of the invention.

It should also be noted that the range of motion of the main links 12 depends upon the length of the connection links 14 and the number of pivotal couplers that serially connect the connection segments 16. The longer the connection link 14 extending between two adjacent main links 12, the greater the range of motion they will have, and the more pivotal couplers between adjacent main links, the greater the range of freedom.

Due in part to the simplicity of the design of spherical joints 10A through 10D, the spherical joints 10 are completely scalable in size. Using current manufacturing techniques such as, but not limited to, stereo lithography and material disposition, the size of the spherical joints 10 can be made in the millimeter range and larger, and future manufacturing techniques could enable the spherical joints to be even smaller.

In addition, the spherical joints 10 are also completely scalable in the number of main links. For example, spherical joint 10A includes two main links (see FIG. 1) whereas spherical joint 10B includes four main links (see FIG. 2) and spherical joint 10C includes three main links (see FIG. 3). Furthermore, it should be noted that the number of connection segments 16 which, make up a connection link 14 is a design choice. The only constraint is that the number of connection segments 16 that make up a connection link 14 is at least two and that the two connection segments 16 are pivotally coupled together. Furthermore, it is noted that each of the connection link 14 of a spherical joint 10 need not contain the same number of connection segments 16. For example, referring to FIG. 3, the connection link 14B includes three connection segments 16C through 16E, and the connection link 14D includes four connection segments 16.

As previously stated hereinabove, the non-limiting example of spherical joints 10A-10D are scalable in size such that they can be used in applications ranging from the minute scale to the very large scale. In one non-limiting example, spherical joints are used in the skeleton of digital clay. Details of digital clay can be found in U.S. patent application entitled “DIGITAL CLAY APPARATUS AND METHOD” filed on Jun. 7, 2002, and accorded Ser. No. 10/164,888, which is entirely incorporated herein by reference.

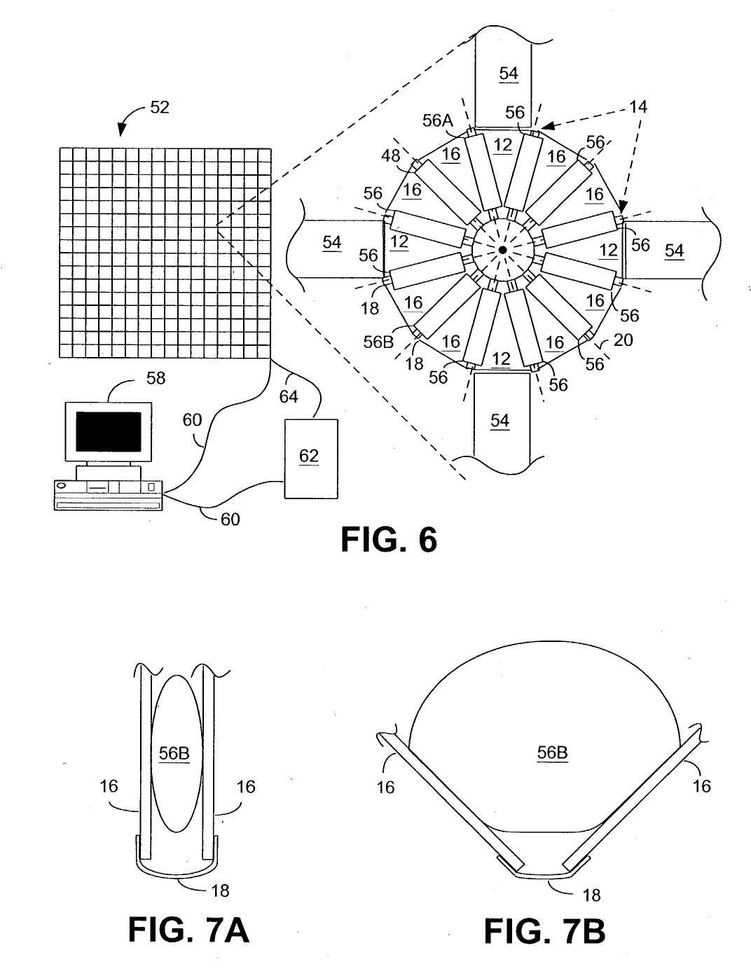

Referring to FIG. 6, digital clay 52 is made up of multiple spherical joints 10 arranged in a grid. Each of the spherical joints is attached to the nearest neighbors by connectors 54 such that the connectors 54 extend between main links 12 of adjacent spherical joints 10. In this embodiment, the spherical joints 10 include multiple link positioners 56.

Each one of the multiple link positioners 56 extends from one member to another member across one of the pivotal couplers 18. For example, the link positioner 56a extends from a main link 12 to a connection segment 16 and the link positioner 56b extends over a pivotal coupler 18 to adjacent connection segments 16. The link positioner 56 is attached to adjacent links and is used to position and/or maintain the position of the adjacent links.

In the preferred embodiment, each one of the spherical links 10 of the digital clay 52 is in communication with a computer 58. The computer 58 is in electrical communication with the digital clay 52 and with an actuator 62 via electrical wiring 60 or via wireless communication. The actuator 62 is in communication with the link positioners 56 of the spherical links 10 that make up the digital clay 52 via communication link 64.

A user of the digital clay 52 can physically manipulate the digital clay 52 into a desired configuration. The actuator 62 responds to the physical manipulation of the digital clay 52, by maintaining the link positioners 56 in that configuration. The relative orientations of the connectors 54 are provided to the computer 58, which then displays an image of the digital clay in that configuration. Thus, in one embodiment, digital clay is used for, among other things, computer art and computer design. Alternatively, in one embodiment, the computer is adapted to provide relative positioning signals to the actuator 62, which then causes each of the link positioners 56 of each spherical link 10 of the digital clay 52 to be aligned in a predetermined manner, thereby causing the digital clay 52 to be configured according to the relative positioning signals.

In the preferred embodiment, the link positioners are hydraulic/pneumatic bladders, which are expandable and contractible. The link positioner 56b is illustrated in FIG. 7A and 7B in deflated and partially inflated states, respectively. In this exemplary embodiment, the pivotal coupler 18 is a flexure joint, which is made from a flexible material such as plastic and which is adhered to the connection segments 16. The flexure joint 18 enables the pair of connection segments 16 to open and close as the link positioner 56b is inflated and deflated.

The link positioner 56b is adhered to the adjacent connection segment 16 so that when the link positioner is deflated, it pulls the adjacent connection segments toward each other. Conversely, when the link positioner 56 is inflated, it pushes against the adjacent connection segment 16, causing them to pivotally separate around the axis of rotation defined by the pivotal connector 18.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A joint mechanism comprising:
a plurality of main links having a first main link and a last main link, the plurality of main links arranged from the first to the last main link such that each main link defines an axis, and the axes intersect at a given point; and
a plurality of connection links, the plurality of connection links serially connecting the plurality of main links such that each main link is pivotally coupled by a pair of connection links, each connection link having multiple pivotally connected segments, wherein each pivotally connected segment of each connection link pivots about an axis of rotation that intersects the given point.

2. The joint mechanism of claim 1, wherein the multiple segments of a given connection link includes a first segment having a first end and a second end and a second segment having a third end and a fourth end, the first end of the first segment pivotally coupled to the first main link, the fourth end of the second segment pivotally coupled to the last main link.

3. The joint mechanism of claim 2, wherein the multiple segments of the given connection link further includes at least a third segment having a fifth end and a sixth end, the second end of the first segment pivotally coupled to fifth end of the at least third segment, and the sixth end of the at least third segment pivotally coupled to the third end of the second segment.

4. The joint mechanism of claim 3, wherein the at least third segment is made from multiple segments that are pivotally and serially connected together.

5. The joint mechanism of claim 1, wherein the first main link includes a pin aligned along the axis defined by the first main link.

6. The joint mechanism of claim 5, wherein the plurality of connection links include a first connection link and a second connection link, the first and second connection links each having a generally tubular region, wherein the pin of the first main link extends at least partially through the generally tubular regions of the first and second connection links.

7. The joint mechanism of claim 1, further including:
a flexure joint defining an axis of rotation, the axis of rotation intersecting the given point, the flexure joint pivotally coupling the first main link to a given connection link.

8. The joint mechanism of claim 1, wherein the plurality of main links are the first main link and the last main link.

9. The joint mechanism of claim 1, wherein the plurality of main links includes the first main link, the last main link, and an at least third main link.

10. The joint mechanism of claim 1, wherein the at least third main link includes multiple main links.

11. A joint mechanism comprising:
a plurality of coupling assemblies, each coupling assembly having a first connecting segment and a second connecting segment, the first and second connecting segment pivotally coupled together about an axis of rotation;
a plurality of main links, the plurality of main links including a first main link and a last main link, wherein the plurality of main links are arranged from the first main link to the last main link in a predetermined pattern such that each main link has two adjacent main links and such that each main link has two of the plurality of coupling assemblies pivotally coupled thereto, and wherein the axis of rotation of each coupling assembly intersects at a given point.

12. The joint mechanism of claim 11, wherein the first main link includes a pin longitudinally aligned with a second axis, wherein the second axis intersects the given point.

13. The joint mechanism of claim 12, wherein each of the two coupling assemblies pivotally coupled to the first main link pivot about the second axis.

14. The joint mechanism of claim 11, further including:
a flexure joint defining a second axis of rotation, wherein at least one of the two coupling assemblies coupled to the first main link is pivotally coupled to the first main link by the flexure joint, and the second axis of rotation intersects the given point.

15. The joint mechanism of claim 11, wherein at least one coupling assembly of the plurality of coupling assemblies includes at least three connection segments, the at least three connection segments of the at least one coupling assembly are serially and pivotally connect.

16. The joint mechanism of claim 15, wherein each pivotal connection of the at least one coupling assembly defines an axis of rotation that intersect at the given point.

17. A spherical joint mechanism comprising:
a plurality of connection links; and
a plurality of pivotable couplers means serially and pivotally connecting the connection links into a closed loop of circuit, each pivotable coupler means defining an axis of rotation, the axes of rotation intersecting at a given point.

18. The spherical joint mechanism of claim 17, wherein the plurality of pivotable couplers means includes a plurality flexure joints.

19. The spherical joint mechanism of claim 18, wherein the plurality of connection links is at least three.

20. The spherical joint mechanism of claim 18, further including:
a plurality of connectors coupled to the plurality of connection links, wherein the ratio of connection links to connectors is at least three to one, and there are at least two pivotally coupled connection links between adjacent connectors.

21. The spherical joint mechanism of claim 17, wherein the plurality of pivotable coupler means includes a plurality revolute joint, each revolute joint having a pin aligned along one of the axes of rotation.

22. The spherical joint mechanism of claim 21, further including:
a plurality of connectors coupled to the pins, wherein the ratio of connection links to connectors is at least two to one, and there are at least two pivotally coupled connection links between adjacent connectors.

23. Digital clay comprising:
a sheet of spherical joints disposed in a predetermined configuration;
a plurality of connectors extending between nearest-neighbor spherical joints of the sheet of spherical joints; and
positioning means for positioning the sheet of spherical joints in a given shape.

24. The digital clay of claim 23, wherein each spherical joint defines a closed circumference.

25. The digital clay of claim 23, wherein each spherical joint includes:
a plurality of main links having a first main link and a last main link, the plurality of main links arranged from the first to the last main link such that each main link defines an axis, and the axes intersect at a given point; and
a plurality of connection links, the plurality of connection links serially connecting the plurality of main links such that each main link is pivotally coupled by a pair of connection links, each connection link having multiple pivotally coupled connection segments, wherein a pivotal coupler pivotally couples two adjacent connection segments of the multiple connection segments, and the pivotal coupler defines an axis of rotation that intersects the given point.

26. The digital clay of claim 25, wherein the positioning means includes a plurality of link positioners, each link positioner is attached to a pair of adjacent connection segments and extends across a given pivotal coupler disposed between the pair of adjacent connection segments and adapted to pivot the pair of adjacent connection segments about the axis of rotation defined the given pivotal coupler.

27. The digital clay of claim 23, further including:
a processor in communication with the sheet of spherical joints and in communication with the means for positioning, wherein the processor controls the positioning means to position the sheet of spherical joints in a predetermined shape.

28. The digital clay of claim 23, further including:
a processor in communication with the sheet of spherical, the processor is adapted to receive positional information from each of the spherical joints and generate an image of the sheet of spherical joints therefrom.

29. A method of providing a body with three degrees of rotational freedom, the method comprising the steps of:
attaching the body to a first main link of a spherical joint, wherein the spherical joint includes a plurality of main links and a plurality of connection links, the plurality of main links including the first main link and a last main link, the plurality of main links arranged from the first main link to the last main link such that each main link defines an axis, and the axes intersect at a given point, and the plurality of connection links serially connecting the plurality of main links such that each main link is pivotally coupled by a pair of connection links, each connection link having at least two connection segments that are serially and pivotally coupled together, wherein for each pair of adjacent connection segments that are pivotally coupled together there is an axis of rotation about which the pair of connection segments, wherein the axes of rotation intersect at the given point circumscribed by the spherical joint; and
pivoting a given connection segment of a given connection link of the plurality of connection links about an rotational axis, wherein the given connection link is one of the pair of connection links pivotally coupled to the first main link and the given connection link is pivotally coupled to the first main link.

30. The method of claim 29, wherein the pivoting the given connection segment induces a rotation of the first main link thereby rotating the body.

31. The method of claim 29, wherein the pivoting the given connection segment is induced by a rotation of the first main link.
